(19) United States
(12) Patent Application Publication
(10) Pub. No.: US 2004/0047977 A1
(43) Pub. Date: Mar. 11, 2004

(54) Precipitation process for solid sugar and oil products

(75) Inventor: John H. Lee, Olathe, KS (US)

Correspondence Address: John H. Lee, 1441 N Lucy Montgomery Way, Olathe, KS, 66061, US

(73) Assignee: Rigel Technology Corporation, Shawnee, KS

(21) Appl. No.: 10/657,028

(22) Filed: Sep. 8, 2003

Related U.S. Application Data
(63) Continuation-in-part of application No. 09/920,125, filed on Aug. 1, 2001, now Pat. No. 6,368,657.

(51) Int. Cl. A23G 3/00

(52) U.S. Cl. 426/658

(57) ABSTRACT

The present invention provides the novel process to form new solid sugar-protein, sugar-fat, and sugar-protein-fat products. The precipitation process converts normal molasses and fat products with sticky and oily physical characteristics into the new solid products such as sugar-protein and sugar-protein-fat products without sticky and oily physical characteristics.

### CROSS-REFERENCE TO RELATED APPLICATION

This application is a continuation-in-part application of U.S. application Ser. No. 09/920,125, filed on Aug. 1, 2001, now U.S. Pat. No. 6,368,657.

### BACKGROUND OF THE INVENTION

Molasses is a liquid sugar by-product, which comes from the processes of cane or beet sugar, corn ethanol, soybean protein and other products. Molasses contains sugar, ash, protein and others. The molasses sugar products are often concentrated into a viscous and sticky liquid at solids such as 50-80% by a vacuum heat process. It is very difficult to convert the liquid molasses products into solid products in particle form without the effects by heat and moisture. Molasses becomes much more soft by heat. Also molasses dissolves into water. For feed applications, molasses is often used for liquid feeds, animal blocks and as a general feed ingredient. For animal feed block supplement, the block product is a large block piece, which is described by U.S. Pat. Nos. 6,440,478, 6,168,803, 5,755,178, 5,622,739 and 3,961,081. Lactose whey is a liquid sugar by-product, which comes from cheese, whey protein or pure lactose processing. Milk contains lactose, casein and whey proteins. After cheese processing, the mixture of whey proteins and lactose is processed by an ultra filtration to separate into whey protein fraction and lactose fraction. Pure lactose product is produced from the lactose fraction. Lactose whey has similar characteristics as molasses. The concentrated lactose whey is a viscous and sticky liquid. Lactose whey has a light color. Molasses has a dark color. U.S. Pat. No. 6,368,657 discloses a precipitation process to convert liquid molasses or lactose whey with liquid animal blood into solid products in particle form without the effects of heat and moisture. But the product has dark color. Also there is no fat in the solid products. This invention has further developed more practical products with better functions. Besides the solid sugar-protein products, new solid sugar-protein-fat and sugar-fat products have been developed. Fat increases the energy value for feed products. The new solid sugar-protein-fat products improve the fat and molasses properties, which are not effected by heat and moisture. Fat is a liquid oil form under heat. The process in this invention also converts the liquid oil into solid fat. The products are improved with lighter color and mild smell by peroxide treatment.

Vegetable soap stock such as soy, corn or canola oil soap stock is the vegetable oil by-product during vegetable oil process. Hydrolyzed vegetable or animal oil is obtained after hydrolyzed processes such as hydrolyzed fish or tallow oil. It has been found by this present invention that vegetable or animal soap stock or hydrolyzed oil is used as an oil ingredient into the liquid sugar and protein to be processed to form solid sugar-protein-fat precipitation products without oily and sticky physical properties. The new solid precipitation products can withstand the heat and moisture without changing product properties, which are totally different from normal molasses or oil products. The products can be either wet or dry solid form. Also vegetable soap stock such as soy, corn or canola oil soap stock can be converted into new solid precipitation products with such as agar, cellulose, milk, casein, whey, plasma, egg or soy protein. When a blender such as homogenizer or high speed agitation is used, the wet soft solid protein-fat product is easily broken into very fine pieces and the liquid with the fine pieces is dried by a spray dryer into powder form.

Over the years, various attempts have been made to make solid molasses or fat products. A number of patents have been issued to make the products by some special treatments. U.S. Pat. No. 6,576,667 discloses a process method to manufacturing fatty acid calcium salts in solid form from high glyceride content oils. U.S. Pat. No. 6,440,478 discloses a process to produce an improved feed molasses block in which a fluid mixture comprising molasses, additives and other nutrients into a dehydration vessel operating under a partial vacuum. Once an appropriate amount of water has been removed, the dehydrated fluid mixture is formed into block shape and cooled to form feed solid blocks. U.S. Pat. No. 6,436,461 discloses a process to prepare the gel beads containing acid polysaccharide (carbohydrate) and voltaile liquid ingredient by forming of discrete droplets and converting the droplets into water-insoluble gel beads by introducing the droplets in a solution with multivalent cations. The ingredient consists flavors, fragrances, vitamins or coloring materials. U.S. Pat. No. 6,229,031 discloses a process method for the preparation of fatty acid calcium salt, which can be used as rumen bypass feed supplements. Fatty acid, calcium oxide and water is heated to a temperature at which the fatty acid glycerides saponify to form fatty acid calcium salt. U.S. Pat. No. 6,153,236 discloses a process for low melt encapsulition with high laurate canola oil. U.S. Pat. No. 5,928,687 discloses a rumen bypass feed supplement in the form of a matrix containing biologically active material, protective substance, and surface coating impervious to attack in the rumen. U.S. Pat. No. 5,874,102 discloses a process to prepare a dietary fatty acid salt product in granulated form, which can function as a rumen bypass animal feed supplement. U.S. Pat. No. 5,514,388 discloses a process to treat protein with a base to increase the pH to such as 12 at first. Then the fat is added into the alkali protein. The protein firm gel product is formed when the pH is lowed to 3 to 5. U.S. Pat. No. 5,143,737 discloses a process method to produce unsaturated milk fat or meat fat to be encapsulated with an acid sensitive nontoxic crosslinkable material. U.S. Pat. No. 4,808,429 discloses a process to encapsulate animal blood and fat by heating to a temperature in the range 40-45 degree C. and homogenizing into a dispersion or emulsion. Then the mixture was allowed to cool for forming a gel product and then dried. U.S. Pat. No. 4,217,370 discloses a process to treat protein with a base to increase the pH such as 11 at first. Then the fat is added into the alkali protein. The protein and fat are mixed together. The protein-fat gel product is formed when the pH is lowed to the isoelectric point. U.S. Pat. No. 4,216,234 discloses a process to render albumin containing medium with strongly alkaline (e.g. pH 11) prior to the formation of the fat dispersion or emulsion. The fat is encapsulated to form a gel-form product. U.S. Pat. No. 4,138,505 discloses a process to heat animal blood to a temperature in the range of from about 20 to about 60 degree C., to adjust the pH of the heated aqueous medium to a strongly alkaline such as pH 12 to form a blood solid gel, and thereafter recovering the fat-protein gel. U.S. Pat. No. 3,961,081 discloses a method to prepare a solid molasses feed block for animals. The block embodies molasses solids as a primary structural and nutritional constituent, which provides the ingredients and advantages of a liquid feed supplement in solid form.

### SUMMARY OF THE INVENTION

The present invention provides the precipitation process to form solid sugar-protein and sugar-protein-fat precipitation products.

For preparing solid sugar-protein or sugar-protein-fat precipitation products, liquid molasses or lactose whey is mixed with liquid animal blood, which is animal whole blood or red blood cells such as from pork, beef and poultry. If an oil ingredient such as soy or corn soap stock is added into the liquid sugar by-product and protein ingredients, the new solid product is processed to have a fat content such as 30% without oily physical characteristics. A normal product with the the soap stock at a fat content such as 30% is very oily. Some chemical such as calcium or manganese in oxide or hydroxide form is added for combining more fatty acid oil to form the soap under heat treatment into the solid product. The value of pH is checked and adjusted. Then a direct or non-direct heat source is applied to raise the temperature to above 60 degree C. to convert liquid molasses or lactose whey and liquid animal blood into the precipitation solid product by the protein coagulation. If peroxide is added into the wet product, the color is changed to a lighter color such as brown or yellowish compared with the natural black-reddish color of dried animal blood meal without peroxide treatment. The color change depends on the added level of the peroxide. The free water in the wet solid product is removed by a press, screen or centrifuge to reduce the drying cost if there is free water. Then the wet solid product is dried by a dryer. The solid precipitation product has no sticky physical characteristics. Normal wet molasses is always a liquid form under heat. The molasses at very low moisture level can form solid product after cooling down, which becomes soft under heat and dissolves into water. This process changes the molasses properties. There are no similar effects by heat and moisture to the new solid precipitation product, which is totally different from normal molasses or oil products. Lactose whey is used similar to molasses. Besides dry solid product with longer shelf time, the wet solid product may be used in some applications. Peroxide treatment improves the product with light color and mild smell, which is from hydrogen peroxide, calcium peroxide or sodium peroxide. The treatment increases the coagulation and improves energy consumption in the heat process, waste water situation, and micro counts.

Vegetable soap stock such as soy, corn or canola oil soap stock, which is the vegetable oil byproduct produced during vegetable oil process, or hydrolyzed oil is easily mixed into liquid sugar by-product and liquid animal blood and heated to form the new solid sugar-protein-fat precipitation product by the protein coagulation. The new solid precipitation product has no oily and sticky physical characteristics. Also new precipitation soap stock products are formed with some proteins or carbohydrates after coagulation, which have no oily physical characteristics. Besides as a general nutritional ingredient, the protein-fat or sugar-protein-fat precipitation products can be used as by-pass ingredients for dairy animals to produce more milk. The reason may be the hydrophilic groups of vegetable or animal soap stock or hydrolyzed oil bind to wet protein or/and carbohydrate ingredients and then the hydrophobic groups of the soap stock or hydrolyzed oil are encapsulated during the protein or carbohydrate coagulation process to form the precipitation product without oily physical characteristics. Some protein and carbohydrate ingredients have the coagulation function under temperature or pH change (to higher or lower) treatment such as milk, casein, whey, soy, plasma, gluten, egg, and rice protein, agar, molasses, starch, and cellulose besides animal whole blood and red blood cells.

Fat provides energy for animals. Molasses and other sugars provide sweet taste. So new solid sweet protein, sweet fat (energy) or sweet protein and fat (energy) products can be made by this invention. For sweet fat product, liquid sugar such as molasses is mixed with animal or vegetable oil at high free and saturated fatty acids or saturated fatty acids such as more than 30% and heated the mixture into a uniform liquid at low moisture level (less than 15%), then the mixture is sprayed and cooled or cooled and ground into solid particles. Most animal or vegetable oil has low saturated fatty acids and does not work. Vacuum process may be used to remove moisture quickly. Saturated fat has high melting point. Molasses coagulates into solids during cooling. The new solid sweet fat product should have good potential in different feed applications. Some cross-linking agents such as calcium and formaldehyde help the encapsulation.

For organic chemicals such as some medicines or flavors, the hydrophobic groups of the organic medicine or flavor bind with the hydrophobic groups of an organic solvent by hydrophobic bonds after the organic solvent is mixed with the organic medicine or flavor. The organic solvent needs to have both hydrophobic and hydrophilic groups. The hydrophilic groups of the organic solvent bind to protein or carbohydrate ingredient and then the hydrophobic groups of the organic solvent and the organic medicine or flavor are encapsulated by the protein or carbohydrate coagulation process with temperature or pH change. Hydrolyzed vegetable or animal oil or soap stock can be used as one solvent with both hydrophobic and hydrophilic groups. The hydrolyzed oil products such as from soybean, sunflower seed, corn, coconut, safflower seed, cotton seed, palm, and canola oil ingredients fit the encapsulation process in this invention. There are other solvents with both hydrophobic and hydrophilic groups. If the organic medicine or flavor itself has both hydrophobic and hydrophilic groups, the organic solvent is not necessary to be needed for encapsulating the organic medicine or flavor. The encapsulated organic medicine or flavor has the function to be released slowly in human or animal bodies. The medicine release from the biodegradable protein or carbohydrate polymer is dependent on the polymer erosion to affect the delivery system in the bodies. The medicine is released slowly. This encapsulation process in this invention is more practical for large-scale production than the cross-linked carbohydrate amylose or cellulose product with even toxic cross-linking chemicals to form a matrix for the slow release of medicine agents, which are described in such as U.S. Pat. Nos. 6,419,957, 6,284,273, 5,989,589, 5,807,575, and 5,456,921. The present precipitation process is a more economic and practical process, which may be used to make the encapsulation process easily commercialized.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### EXAMPLE 1

Liquid beet molasses (50 grams at 80% solids) was mixed with liquid pork red blood cells (92 grams at 30% solids). Then mixture was mixed and heated to 85° C. for 1 minutes. The wet precipitation product mixture was dried in an oven at 105° C. for 4 hours. The solid product was easily broken into small particles. The analytical data were follows: protein (39.8%), moisture (7.8%), and ash (8.3%). The product had no sticky physical characteristics.

### EXAMPLE 2

Liquid cane molasses (16 grams at 79% solids) was mixed with soy hydrolyzed oil (17 grams processed from soy soap stock) and heated to 55° C. and then mixed with calcium oxide (0.5 grams) and liquid pork red blood cells (68 grams at 30% solids and 30° C.). Then mixture was mixed and heated to 75° C. for 0.5 minutes. Then 2 ml of 30% hydrogen peroxide was added into the wet precipitation product and mixed. The wet product was dried in an oven at 105° C. for 5 hours. The solid product was easily broken into small particles. The analytical data were follows: fat (30.1%), protein (41.6%), moisture (6.9%), and ash (8.8%). The product had no oily and sticky physical characteristics.

### EXAMPLE 3

Liquid lactose whey (30 grams at 45% solids) was mixed with and liquid pork whole blood (42 grams at 20% solids). Then mixture was mixed and heated to 85° C. for 0.5 minutes. Then 1.5 ml of 30% hydrogen peroxide was added into the wet precipitation product and mixed. The wet product was dried in an oven at 105° C. for 5 hours. The analytical data were follows: protein (36.7%), moisture (5.2%), and ash (8.6%). The product had no stick physical characteristics.

### EXAMPLE 4

Liquid cane molasses (29 grams at 79% solids) was mixed with soy soap stock (45 grams at 50% solid) and heated to 50° C. and then mixed liquid pork red blood cells (105 grams at 30% solids and 30° C.). Then mixture was mixed and heated to 80° C. for 1 minutes. Then 3 ml of 30% hydrogen peroxide was added into the wet precipitation product and mixed. The wet product was dried in an oven at 105° C. for 5 hours. The solid product was easily broken into small particles. The analytical data were follows: protein (46.6%), fat (32.3%), moisture (7.7%), and ash (6.8%). The pepsin digestibility for protein was 95.6%. The product had no oily and stick physical characteristics. The product had the by-pass protein (96.3%) and by-pass fat (38.5%) by the incubation in rumen fluid for 24 hours and the by-pass protein (89.2%) and by-pass fat (38.4%) by the incubation in rumen fluid for 48 hours.

### EXAMPLE 5

Flavor in hydrolyzed vegetable oil (30 grams) was mixed with egg white (85 grams) and liquid milk (150 grams). The mixture was blended and heated from 25 to 82° C. The liquid was uniform without oily feeling. The analytical data were follows: solid (22.2%), protein (5.8%), and fat (11.0%).

### EXAMPLE 6

Wet agar (164 g) was mixed with soy soap stock (120 g), and Rigel 1010 (0.5 ml). The mixture was dried in an oven at 105° C. for 4 hours. The analytical data were as follows: moisture (6.2%), fat (33.8%), and ash (5.1%). The product had no oily physical characteristics.

### EXAMPLE 7

Soy protein concentrate (100 grams at 10% solid) was mixed with soy soap stock (15 grams at 50% solid). Then mixture was blended into a uniform liquid. The pH of the mixture was changed to 3.0 with 10% hydrochloric acid. The uniform liquid was dried in an oven at 105° C. for 7 hours. The solid product was ground into small particles. The analytical data were follows: fat (36.2%), protein (35.1%), moisture (5.8%), and ash (7.3%). The product had no oily physical characteristics.

### EXAMPLE 8

Liquid beet molasses (60 grams at 80% solid) was mixed with partially hydrogenated pork fat (48 grams at 99% crude fat and >80% saturated fatty acids) and heated to 100° C. for 8 minutes. The uniform liquid mixture was dropped into the pieces at about 0.5 to 1 cm length. After setting and cooling at room temperature for 2 hours, the mixture became the solid product. The solid sugar-fat product was ground into small particles by a coffee grinder. The analytical data were follows: fat (48.2%), protein (5.2%), moisture (5.9%), and ash (4.3%).

### EXAMPLE 9

Soy soap stock (50 grams at 50% solid) was mixed with liquid pork red blood cells (85 grams at 30% solids and 30° C.). Then mixture was mixed and heated to 80° C. for 0.5 minutes. The wet product was dried in an oven at 105° C. for 5 hours. The solid product was easily broken into small particles. The analytical data were follows: fat (35.2%), protein (45.1%), moisture (5.6%), and ash (5.7%). The product had the by-pass protein (96.2%) and by-pass fat (62.7%) by the incubation in rumen fluid for 24 hours and the by-pass protein (86.6%) and by-pass fat (59.1%) by the incubation in rumen fluid for 48 hours. The product had no oily physical characteristics.

What is claimed is:

1. A method of preparing a solid sugar precipitation product comprising mixing a liquid sugar by-product with animal blood at pH from 5 to 12 and heating the mixture to a temperature above 60° C. to form the product.

2. The method of claim 1 wherein the liquid sugar by-product is molasses from the processes of beet or cane sugar, corn or soybean, and lactose whey from the processes of cheese, lactose, or whey protein.

3. The method of claim 1 wherein the animal blood is animal whole blood or red blood cells.

4. The method of claim 1 wherein an oil ingredient of vegetable or animal soap stock or hydrolyzed oil is added in the process to form sugar, protein and fat product without oily physical characteristics.

5. The method of claim 1 wherein calcium or manganese in oxide or hydroxide form is used in the process.

6. The method of claim 1 wherein a peroxide of hydrogen peroxide, sodium peroxide or calcium peroxide is used in the process.

7. The method of claim 1 wherein the product is used as a by-pass ingredient for dairy animals besides as a general ingredient for nutritional applications.

8. The method of claim 1 wherein the product is wet or dry form.

9. A method of preparing a solid vegetable or animal soap stock or hydrolyzed oil precipitation product comprising mixing a vegetable or animal soap stock or hydrolyzed oil ingredient with a protein ingredient at pH 2 to 12, and heating the mixture to a temperature above 25° C. to form the product.

10. The method of claim 9 wherein the protein ingredient has the coagulation function under heat or pH change.

11. The method of claim 9 wherein a blender is used to blend the wet liquid product and then a spray dyer is used to produce the solid product in powder form.

12. The method of claim 9 wherein calcium or manganese in oxide or hydroxide form is used in the process.

13. The method of claim 9 wherein a peroxide is used in the process.

14. The method of claim 9 wherein the product is used as a by-pass ingredient for dairy animals besides as a general ingredient for nutritional applications.

15. The method of claim 9 wherein the product is wet or dry form without oily physical characteristics.

16. A method of preparing a solid oil precipitation product comprising mixing a vegetable or animal soap stock or hydrolyzed oil ingredient with a carbohydrate ingredient and changing the temperature for the mixture to form the product without oily physical characteristics.

17. The method of claim 16 wherein the carbohydrate ingredient has the coagulation function under temperature or pH change.

18. The method of claim 16 wherein calcium or manganese in oxide or hydroxide form is used in the process.

19. The method of claim 16 wherein the product is wet or dry form.

20. A method of preparing a solid sugar and fat product comprising mixing molasses or sugar and a vegetable or animal oil ingredient with saturated and free fatty acids or saturated fatty acids in liquid form, heating the mixture to above to a temperature above 60° C. until to a moisture level less than 15%, and spraying and cooling or cooling and grinding the mixture to form the solid product.

21. The method of claim 20 wherein the vegetable or animal oil ingredient has saturated and free fatty acids or saturated fatty acids more than 30%.

22. The method of claim 20 wherein calcium or manganese in oxide or hydroxide form is used in the process.

23. The method of claim 20 wherein the product is dry form.

24. A method of preparing a solid organic chemical or flavor product comprising mixing an organic chemical or flavor and organic solvent with a carbohydrate or protein ingredient at pH 2 to 10, changing the temperature for the mixture, and drying to form the solid product.

25. The method of claim 24 wherein the organic solvent has both hydrophobic and hydrophilic properties and the organic solvent is not necessary to be needed if the organic chemical or flavor has both hydrophobic and hydrophilic properties.

26. The method of claim 24 wherein the protein or carbohydrate ingredient has the coagulation function under temperature or pH change.

27. The method of claim 24 wherein the product is wet or dry form.
